(19) United States
(12) Patent Application Publication
(10) Pub. No.: US 2001/0046539 A1
(43) Pub. Date: Nov. 29, 2001

(54) Process for preparing a shellfish product and product obtained

(76) Inventors: John Charles Turner, Nelson (NZ); Duncan John McFarlane, Nelson (NZ); Noel Arthur Turner, Wangani (NZ)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/901,234

(22) Filed: Jul. 9, 2001

Related U.S. Application Data
(63) Continuation of application No. 08/504,770, filed on Jul. 20, 1995.

(30) Foreign Application Priority Data
Jan. 12, 1995 (NZ) 270330

(51) Int. Cl. A23L 1/325

(52) U.S. Cl. 426/404; 426/643; 426/401; 426/393

(57) ABSTRACT

A process for preparing shellfish for storage comprising the steps of vacuum packing live shellfish within a suitable container and then heating the shellfish to a temperature of between 80° C. and 110° C. and a pressure of between 0.8-2.0 kg_{f}/cm², said temperature and pressure level being sufficiently high to pasteurize the shellfish while preventing substantial expansion of the container yet sufficiently low so as to minimize vaporization of internal juices and preventing substantially all of the shellfish meat from becoming mushy, thereby maintaining substantially all of the natural juices of the shellfish within the shells and maintaining any inadvertently escaped juices to remain in association with the shellfish from which it originated and within said container, said container being suitable for freezing and transport so that both the shellfish and any inadvertent juices remain together during transport.

### FIELD OF THE INVENTION

The present invention relates generally to a method of preparing and packaging shellfish, including bivalves such as mussels or clams. The present invention also generally relates to the product resulting from this new method.

### BACKGROUND OF THE INVENTION

Shellfish are enjoyed worldwide. The problem faced by those that distribute shellfish is preserving the shellfish so that it is delicious and free from contamination in as cost efficient and practical manner as possible. Traditionally, shellfish are prepared for packaging and distribution by cooking the shellfish live and quickly chilling or freezing the shellfish for immediate packaging. In many cases, the shellfish is vacuum packed for longer term preservation. Mussels and other bivalves, in particular, have been prepared by cooking the live mussels in their shells, removing the mussels from their shells (or at least removing one of the two opposing shells and leaving the mussel in the remaining half-shell), freezing the mussels and packaging the mussels into a container.

Variations of this traditional process have been performed. For example live mussels may be cooked, removed from shells or half the shell removed, optionally smoked, and vacuum packed and frozen. Another process simply involves packing uncooked mussels and freezing in their shells. In another process mussels are cooked and then the mussel meat is placed in a marinade, and the product is then chilled.

Methods of packaging and/or preparing seafood are described in U.S. Pat. Nos. 2,546,428 to Byrd, 2,920,968 to Grandy, 3,099,567 to Wallace, et al., 3,508,930 to Bennett, et al., 4,336,274 to Ross, et al., and 5,256,434 to Conway. Byrd describes a process in which crabmeat is first removed from the shell before it is put in a vacuum-sealed container. The Byrd process next includes heating the meat to a level sufficient to kill any bacteria without fully cooking the meat and quickly chilling the meat for long-term refrigeration.

The patent to Grandy relates more to the packaging of individual shellfish pieces, rather than the preparation of the shellfish meat itself Similarly, the patent to Wallace relates to the storage of individual bivalves for freezing, heating, and/or serving. Again, the focus of Wallace is in the packaging of the individual shellfish components, rather than the preparation of the shellfish for long-term storage. Wallace describes a container for maintaining clams in a horizontal position with accommodations to keep the clams alive for as long as possible during shipment. The Bennett patent discloses similar packaging for storing live clams.

The Ross patent describes a process of quick freezing whole crabs that involves the steps of quickly cooking the crabs in hot water, chilling the crabs, and then quick freezing the crabs for long-term storage. The patent to Conway describes a method of enclosing soft-shell crabs for cryogenic freezing and shipment.

U.S. Pat. No. 4,659,574 to Carlsson discloses a method of preparing mussels in which the mussels are placed in a perforated inner container housed within an outer container. The mussels are emersed in water and heated to a point sufficiently high to induce the mussels to open. According to Carlsson, the mussels are sufficiently compacted in a group to prevent the mussels from opening too far. The mussels are then cooled and then deep frozen in their compacted condition and then packaged. The processing liquid that collects around the mussels is then frozen for later use in final preparation of the mussels prior to their consumption. Compaction of the mussels is achieved by tightening a lid down on the group of mussels enclosed within the inner container.

The traditional process of preparing and packaging shellfish has a disadvantage in that it is vulnerable to contamination by bacteria, especially listeria, because, after cooking, there is a time delay before bagging of the mussels and sealing of the bags. Listeria is a particular problem because of its ability to thrive at low temperatures. It also has the problem in that the shells tend to open during cooking, permitting the natural mussel juices and any seawater flavor trapped within the mussels to escape. To overcome that, at least one person has considered compacting the bivalves so close together as to minimize opening of the bivalves when heated. See Carlsson patent described above. That method does not entirely solve the problem because there is still an escape of internal juices. It is also more complicated in that the juices that do escape are not contained very effectively. The juices necessarily separate from the mussels, necessitating duplicative handling. Moreover, the collection of loose mussels in the porous internal container of Carlsson requires dual handling as the processed mussels must then be collected and bagged. While other processes have involved applying pressure to the exterior of the mussels, those processes involve pressures and temperatures that leave the mussel mushy and virtually tasteless; unacceptable fare for discriminating palates. They also fail to properly address the listeria problems.

### SUMMARY OF THE INVENTION

It is therefore an object of the present invention to provide an improved process of preparing and packaging shellfish for long term storage that minimizes the bacterial contamination risk associated with the traditional process while more effectively retaining the natural mussel juices and seawater flavor of the shellfish in the final product. It is also an object of the present invention to minimize the duplicative handling of the shellfish during the process.

The present invention process comprises the steps of sealing the live shellfish in a single-tier or multi-tier arrangement within a vacuum pack and heating the sealed package of shellfish sufficiently to pasteurize the shellfish but not to fully cook the shellfish. The process also includes an overpressure step of applying sufficient hydrostatic pressure to the package of shellfish to maintain all of the internal juices within the shell. Any inadvertent escape of juices are confined within the container of shellfish in close association with the shellfish from which the juices originated. After that step, the shellfish may be quickly frozen for long term storage, rather than undesirably stored at ambient pressures on a shelf.

Preferably the shellfish are packed and cooked in their whole shells but, alternatively prior to packing and cooking, the meat may be removed from the shellfish or at least one of the two opposing shell halves can be removed so that the shellfish are packed and cooked in the remaining half-shell.

### BRIEF DESCRIPTION OF THE DRAWINGS

FIG. 1 is a perspective view of the cooked mussel product in its vacuum pack.

FIG. 2 is a cross-sectional view of the resulting product.

### DETAILED DESCRIPTION OF THE INVENTION

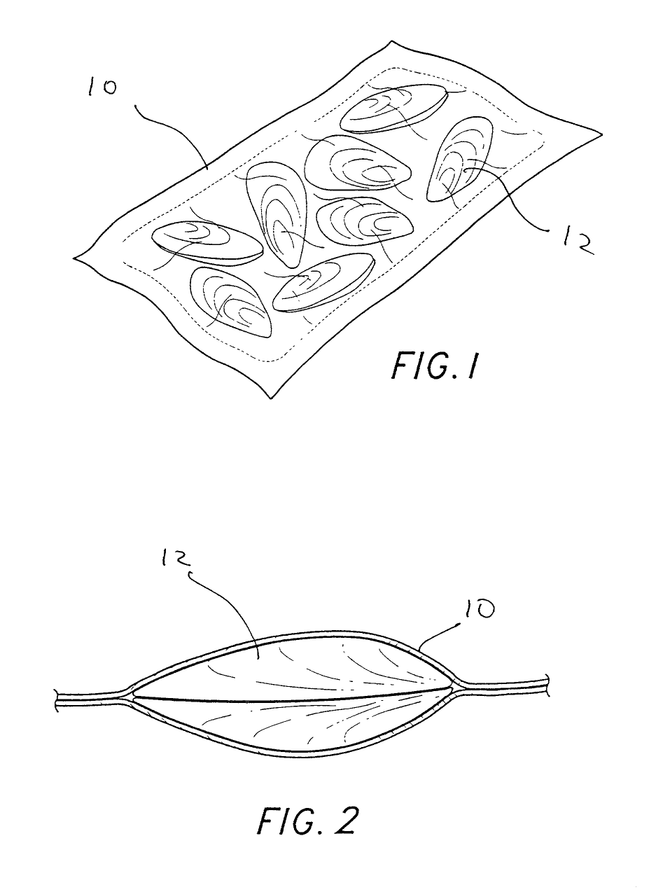

Reference is now made to the figures wherein like parts are designated with like numerals throughout. Referring first to FIG. 1, the present invention comprises a process for preparing and packaging shellfish for long term storage. The process includes placing one or more mussels into an impervious container 10 having at least one opening (not shown) for introducing live shellfish such as mussels 12 therethrough. Preferably, the opening must be such that it may be thermally sealed (i.e., melted) to contain all fluids therein during subsequent heating and pressurizing steps described below. In a preferred embodiment of the process live mussels or other shellfish are subjected to shell washing (if necessary) before being placed in the container 10.

Following introduction into the container 10, the shellfish are then hermetically vacuum sealed within the impervious container 10, preferably so as to draw the container closely to the shellfish. Referring to FIG. 2, a single mussel 12 is shown closely sealed within a portion of the container 10 so that virtually no air exists within the vacuum-sealed container. In one embodiment, the live shellfish are placed in a single-tier arrangement within the container 10 as shown in FIG. 1. It is also contemplated that the mussels be placed in an overlapping format, even in a multiple tiered arrangement if desired.

The inventive process herein also includes the step of heating the sealed package of shellfish sufficiently to “pasteurize” the shellfish; a level of sterilization that is sufficient to eliminate listeria and other bacteria and is efficiently performed without radically altering taste or quality. Pasteurizing requires a shorter time and/or a lower temperature, preferably between 80-110° C., than does a typical sterilization process of the prior art. Most preferably conducted at 100° C. but permissibly conducted at other temperatures depending upon the time desired, the pasteurization process kills bacteria that cause spoilage or undesirable fermentation, particularly listeria, without the need to include any additives or preservatives. Pasteurization also results in a more palatable shellfish product that is not mushy. Having been pasteurized effectively, the product can be stored long term in a frozen condition, as described below, instead of at ambient pressures in a shelf-stable condition. The latter not only has a shorter period of safe consumption but is psychologically unappealing to most seafood consumers. Seafood consumers are more secure in the knowledge that the shellfish that they purchase are preserved in a frozen condition rather than sitting unrefrigerated on a shelf, more readily subject to contamination.

The present process also includes a simultaneous overpressure step that comprises applying sufficient pressure, hydrostatic or otherwise, to the container of shellfish while the shellfish are being heated. The purpose of the overpressure step is twofold: one, to prevent the impervious container from expanding, thereby possibly inducing a break in the seal at a weak point in the container; and two, to maintain all of the internal juices within the shell of the shellfish. The heating step normally results in the meat curling up on its self, forcing the shell to open up part way. The heating step also causes vaporization of the internal mussel juices, thereby causing further expansion of the shells. It is that expansion of the shell that leads to the undesired result of releasing internal juices into the surrounding environment. Regardless of whether the shellfish are arranged in a single-tier format or a multi-tier format, the present inventive process minimizes expansion of the shells to maximize the maintenance of internal juices within the shells.

The heating and overpressure steps may be performed in a retort cooker (not shown) in which the container 10 having a mussel or mussels therewithin is immersed in a heated fluid to which a pressure is applied, thereby imparting pressure upon the mussels 12 during the heating process. Retort cookers have been used in the past to sterilize the contents of canned foods, including seafood. The overpressure aspect described above minimizes the inadvertent escape of juices from the shellfish. Advantageously, any inadvertent juices that do manage to escape despite the overpressure step are confined within the container of shellfish and are immediately available to accent the mussels during final preparation without requiring the handling of multiple products, such as that process shown in Carlsson. The overpressure step is important in that it counteracts the tendency of the container to swell during the heating step. That swelling effect may lead to the container bursting during pasteurization. Commercially-available retorts with an over-pressure facility are suitable.

After the above-described steps, the shellfish may be quickly frozen in the container 10 for long term storage. The process of the invention gives a different and better taste to the product by retaining the natural shellfish juices and sea flavor without making the meat mushy and tasteless.

Preferably the impervious container 10 is made of a composite of resilient materials, such as PET19/NY15/CPP70 (19 microns of polyethylene, 15 microns of nylon and 70 microns of Carst polypropylene). The container need not be made of composite material, however, if the results described herein are effectively achieved with other materials. With the specific embodiment of PET19/NY15/CPP70, each of the materials address one potentially adverse aspect of the surrounding environment. The polyethylene prevents the influx and egress of fluid, e.g., surrounding water and internal juices, respectively. The nylon acts as a barrier against the transmission of oxygen. Finally, the polypropylene acts as a heat resistant material. Together, the composite material advantageously withstands the temperature levels and pressure levels necessary to adequately prepare the shellfish as described herein to maintain a sterile environment.

The cooking temperatures are preferably in the range of 80-110° C., although other temperatures may be acceptable in other circumstances depending upon the time permitted or desired. It has been found that these temperatures are sufficient to pasteurize the shellfish without fully cooking the shellfish, permitting additional cooking just prior to consumption. The time of cooking chosen will depend on the size and type of the shellfish and the temperature chosen. Typically it will be in the range 1 minute to 20 minutes. The lower temperatures contemplated by the present invention herein minimize the boiling of mussel juices (vaporization) which, in turn, permits the use of lower pressures to maintain the shells in a closed position. Preferably the pressures employed are in the range of 0.8-2.0 Kg_{f}/cm², although pressures below and above that range are acceptable if the resulting shellfish product is essentially the same as described herein for the process using the above specified range of pressures. The most preferable pressure is 1.3 Kg_{f}/cm²,

In the heating step, the shellfish are preferably cooked at a temperature of about 100° C. for a minimum of 3 minutes and are then cooled. Where the cooking time at 100° C. is near the minimum of 3 minutes, the total cooking process including time to reach 100° C. and cooling time takes approximately 30 minutes. When the product has cooled to an external temperature of 35° C., it is preferred to freeze the product in its vacuum pouch, preferably in a blast freezer.

Any variety of mussel species may be used in the process of the invention including greenshell mussels and blue mussels. Other shellfish that are suitable include King and Queen scallops, flat and Pacific oysters, little necked clams, surf clams, pipies, cockles, and abalone. New Zealand Greenshell Mussels (Perna canaliculus) and new Zealand Blue Mussels (Mytalis galloprovincialis) are a preferred mussel for using the preferred invention. It should be noted that the present process is appropriate for the preparation and packaging of bivalve shellfish such as mussels or alternatively other shellfish such as paua/abalone.

The present invention is exemplified by the following steps:

1. New Zealand Greenshell Mussels are stored alive at 5°-10° C. until processing.

2. The mussel shells are washed in an aluminum drum rotary shell washer using water and rotary action. The washed mussels are then visually checked for broken, over-sized or under-sized mussels, which are then removed.

3. The acceptable mussels are placed into retortable container 10 and hermetically vacuum packed.

4. One or more containers of product are cooked at a temperature of 100° C. and a pressure of about 0.8-2.0 kg_{f}/cm² for 5 minutes in a retort cooker.

5. The containers are retained in the retort cooker and cooled to an external temperature of 35° C. Including the step of cooling to 35° C., the total process takes approximately 30 minutes.

6. The container of shellfish is then unloaded from the retort cooker and placed in a blast freezer where it is blast frozen to achieve a minimum core temperature of minus 18° C. in approximately 3 hours.

7. The frozen product is then ready for packing and shipment.

The process described in the above example merely illustrates the process of the present invention. Various types of shellfish may be used in the process. Moreover, various temperature levels and step durations may be employed, depending upon the shellfish processed. For example, with New Zealand Greenshell mussels having a shell length of 40-60 mm, the preparer may reduce the cooking time to as little as 3 minutes. With abalone, one may wish to increase the cook time to 10-15 minutes.

The invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

What we claim is:

1. A process for preparing shellfish for storage comprising the steps of vacuum packing live shellfish within a suitable container and then heating the shellfish to a temperature of between 80° C. and 110° C. and a pressure of between 0.8-2.0 kg_{f}/cm², said temperature and pressure level being sufficiently high to pasteurize the shellfish while preventing substantial expansion of the container yet sufficiently low so as to minimize vaporization of internal juices and preventing substantially all of the shellfish meat from becoming mushy, thereby maintaining substantially all of the natural juices of the shellfish within the shells and maintaining any inadvertently escaped juices to remain in association with the shellfish from which it originated and within said container, said container being suitable for freezing and transport so that both the shellfish and any inadvertent juices remain together during transport.

2. The process of claim 1 further comprising the step of freezing the shellfish within the container.

3. The process of claim 2 wherein the step of freezing the shellfish involves blast freezing.

4. A process for preparing a shellfish product comprising vacuum packing the shellfish while alive, and cooking the vacuum pack containing the shellfish for sufficiently long to pasteurize the shellfish at a pressure that counteracts the tendency of the pack to expand, so as to capture the natural juices of the shellfish and seawater within the shells within the pack.
